(19) United States
(12) Patent Application Publication
(10) Pub. No.: US 2026/0292726 A1
(43) Pub. Date: Sep. 24, 2026

(54) METHOD AND APPARATUS FOR DEALING WITH TIMING SYNCHRONIZATION FUNCTION SYNCHRONIZATION IN MULTI-ACCESS-POINT SYSTEM

(71) Applicant: MEDIATEK INC., Hsin-Chu (TW)

(72) Inventors: Chien-Fang Hsu, Hsinchu City (TW); James Chih-Shi Yee, San Jose, CA (US); Hao-Hua Kang, Hsinchu City (TW); Chih-Chun Kuo, Hsinchu City (TW)

(73) Assignee: MEDIATEK INC., Hsin-Chu (TW)

(21) Appl. No.: 19/473,484

(22) PCT Filed: Apr. 10, 2024
(86) PCT No.: PCT/CN2024/086990

§ 371 Date: Oct. 8, 2025

Related U.S. Application Data
(60) Provisional application No. 63/495,134, filed on Apr. 10, 2023.
(60) Provisional application No. 63/588,307, filed on Oct. 6, 2023.
(60) Provisional application No. 63/590,479, filed on Oct. 16, 2023.
(60) Provisional application No. 63/592,216, filed on Oct. 23, 2023.

(51) Int. Cl. H04W 56/00

(52) U.S. Cl. CPC H04W 56/0015

(57) ABSTRACT

A timing synchronization function (TSF) synchronization method includes: generating a first TSF information frame, where the first TSF information frame includes first TSF synchronization data, and the first TSF synchronization data includes TSF information of a first access point (AP) of a multi-AP (MAP) system; and sending the first TSF synchronization frame to a second AP of the MAP system.

### BACKGROUND OF THE INVENTION

### 1. Field of the Invention

The present invention relates to wireless communications, and more particularly, to a method and apparatus for dealing with timing synchronization function (TSF) synchronization in a multi-access-point (MAP) system.

### 2. Description of the Prior Art

In an MAP system, there are multiple APs (e.g., AP multilink devices (MLDs)) coordinated to serve non-AP stations (STAs) (e.g., non-AP MLDs). For many applications, these APs need to coordinate the transmit and receive behaviors so that the interference among APs can be mitigated. However, since those APs may not be physically collocated so that their clocks are drifting as time goes by. Thus, there is a need for an innovative timing synchronization design which is capable of synchronizing TSF timers of those APs operating in the same operating channel or operating in the same MAP system.

### SUMMARY OF THE INVENTION

One of the objectives of the claimed invention is to provide a method and apparatus for dealing with TSF synchronization in an MAP.

According to a first aspect of the present invention, an exemplary TSF synchronization method is disclosed. The exemplary TSF synchronization method includes: generating a first TSF information frame, wherein the first TSF information frame comprises first TSF synchronization data, and the first TSF synchronization data comprises TSF information of a first AP of an MAP system; and sending the first TSF synchronization frame to a second AP of the MAP system.

According to a second aspect of the present invention, an exemplary TSF synchronization method is disclosed. The exemplary TSF synchronization method includes: receiving a TSF information frame, wherein the TSF information frame comprises TSF synchronization data, and the TSF synchronization data comprises TSF information of a first AP of an MAP system; and performing TSF synchronization of a second AP of the MAP system according to the first TSF synchronization data.

According to a third aspect of the present invention, an exemplary AP of an MAP system is disclosed. The exemplary AP includes a network interface circuit and a control circuit. The control circuit is arranged to generate a TSF information frame, and instruct the network interface circuit to send the TSF information frame to another AP of the MAP system, wherein the TSF information frame comprises TSF synchronization data, and the TSF synchronization data comprises TSF information of the AP.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an MAP system that supports the proposed TSF synchronization scheme according to an embodiment of the present invention.

FIG. 2 is a diagram illustrating a first TSF synchronization scenario in an MAP system according to an embodiment of the present invention.

FIG. 3 is a diagram illustrating another MAP system that supports the proposed TSF synchronization scheme according to an embodiment of the present invention.

FIG. 4 is a diagram illustrating a second TSF synchronization scenario in an MAP system according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

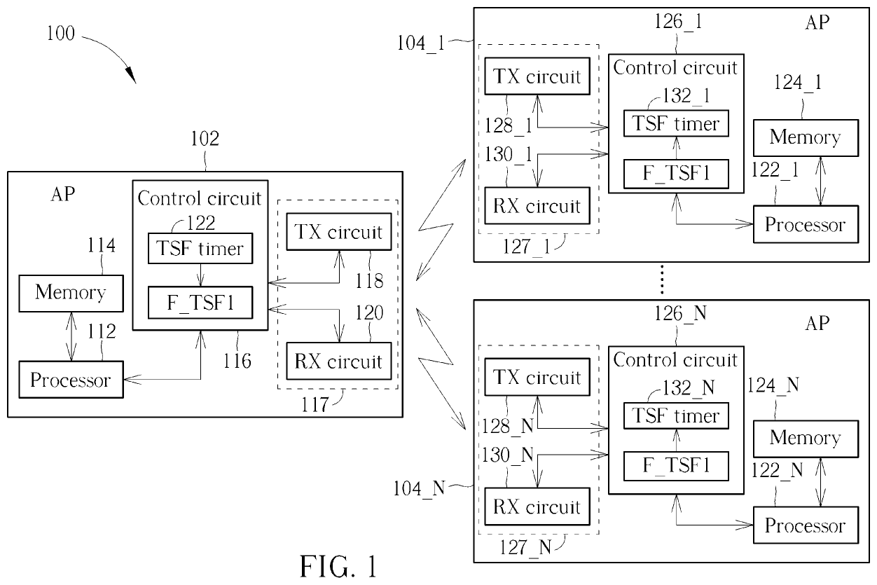

FIG. 1 is a diagram illustrating an MAP system that supports the proposed TSF synchronization scheme according to an embodiment of the present invention. The MAP system 100 may be a Wi-Fi system compliant with IEEE 802.11bn (Wi-Fi 8) standard or a next-generation Wi-Fi standard. The MAP system 100 includes a plurality of APs 102, 104_1-104_N (N≥1). For example, the AP 102 may act as a master AP that initiates TSF synchronization of the MAP system 100, and each of the APs 104_1-104_N may act as a non-master AP that is required to synchronize with the master AP.

It should be noted that an AP of the MAP system 100 may be an AP MLD which owns multiple links working on different RF bands and capable of operating at the same time, or may be a non-MLD AP. Hence, the MAP system 100 that supports the proposed TSF synchronization scheme may be formed by multiple AP MLDs, multiple non-MLD APs, or a combination thereof.

The APs 102, 104_1-104_N may have the same or similar circuit structure. As shown in FIG. 1, the AP 102/104_1/104_N includes a processor 112/122_1/122_N, a memory 114/124_1/124_N, a control circuit 116/126_1/126_N, and a network interface circuit 117/127_1/127_N, where the network interface circuit 117/127_1/127_N includes a transmitter (TX) circuit 118/128_1/128_N and a receiver (RX) circuit 120/130_1/130_N. The memory 114/124_1/124_N is arranged to store a program code. The processor 112/122_1/122_N is arranged to load and execute the program code to manage the AP 102/104_1/104_N. The control circuit 116/126_1/126_N is arranged to control communications with non-AP STAs and other APs. For example, the control circuit 116/126_1/126_N controls the TX circuit 118/128_1/128_N of the network interface circuit 117/127_1/127_N to send frames to non-AP STAs and other APs, and controls the RX circuit 120/122_1/122_N of the network interface circuit 117/127_1/127_N to receive frames from non-AP STAs and other APs.

It should be noted that only the components pertinent to the present invention are illustrated in FIG. 1. In practice, each of APs 102, 104_1-104_N may include additional components to achieve designated functions.

The APs 102, 104_1-104_N in the same MAP system 100 supports the proposed TSF synchronization scheme. The control circuit 116 of the AP 102 (which acts as a master AP) maintains a TSF timer (e.g., a 64-bit counter) 122. The control circuit 126_1 of the AP 104_1 (which acts as a non-master AP) maintains a TSF timer (e.g., a 64-bit counter) 132_1. The control circuit 126_N of the AP 104_N (which acts as a non-master AP) maintains a TSF timer (e.g., a 64-bit counter) 132_N. Local clocks of the APs 102, 104_1-104_N may suffer frequency drifting as time goes by. As a result, values counted by TSF timers 122, 132_1, 132_N maintained at different APs 102, 104_1-104_N in the same MAP system 100 may be out of synchronization. To address this issue, a TSF synchronization scheme is proposed by the present invention to make TSF timers at non-master APs synchronized with the TSF timer at the master AP.

In this embodiment, it is assumed that there exists a backhaul among APs 102, 104_1-104_N in the same MAP system 100, and any of the APs 102, 104_1-104_N can communicate with other APs through the backhaul, where the backhaul may be wired or wireless. However, this is for illustrative purposes only, and is not meant to be a limitation of the present invention. In practice, any means capable of enabling one AP to communicate with another AP may be employed.

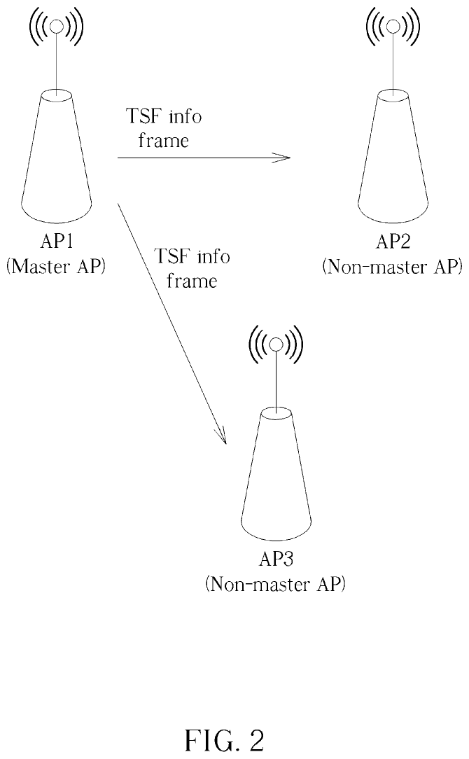

Since the AP 102 acts as the master AP, the AP 102 is in charge of periodically initiating TSF synchronization of the MAP system 100, for ensuring accurate timing synchronization among APs 102, 104_1-104_N in the same MAP system 100. In this embodiment, it is also assumed that APs 104_1-104_N can listen to the AP 102 directly. FIG. 2 is a diagram illustrating a first TSF synchronization scenario in an MAP system according to an embodiment of the present invention. The master AP AP1 may be implemented by the AP 102, and the non-master APs AP2 and AP3 may be implemented by two of the APs 104_1-104_N, where each of the non-master APs AP2 and AP3 can listen to the master AP AP1 directly.

The control circuit 116 of the AP 102 is arranged to generate a TSF information frame F_TSF1, and instruct the network interface circuit 117 (particularly, TX circuit 118 of network interface circuit 117) to send the TSF information frame F_TSF1 to APs 104_1-104_N. For example, the TSF information frame F_TSF1 may be a broadcast frame that can be broadcasted to multiple non-master APs in the MAP system 100. For another embodiment, the TSF information frame F_TSF1 may be a unicast frame that can unicasted to a single non-master AP in the MAP system 100, and the control circuit 116 of the AP 102 needs to generate and send multiple TSF information frames F_TSF1 to multiple non-master APs in the MAP system 100, respectively.

The TSF information frame F_TSF1 is used to carry TSF synchronization data. For example, the TSF synchronization data may include TSF timing of the AP 102 (e.g., a value counted by the TSF timer 122 at the instant the transmission of TSF information frame F_TSF1 occurs/starts), a timing offset corresponding to a delay resulting from processing and transmission of the TSF information frame F_TSF1, an incremental update identifier (ID) indicative of a TSF synchronization revision, or a combination thereof. The TSF information frame F_TSF1 may be a beacon frame or any frame that can carry the information needed by TSF synchronization.

The network interface circuit 127_1 (particularly, RX circuit 130_1 of network interface circuit 127_1) of the AP 104_1 (which acts as a non-master AP) receives the TSF information frame F_TSF1 sent from the network interface circuit 117 (particularly, TX circuit 118 of network interface circuit 117) of the AP 102 (which acts as a master AP), and the control circuit 126_1 of the AP 104_1 obtains the TSF information frame F_TSF1 from the network interface circuit 127_1 (particularly, RX circuit 130_1 of network interface circuit 127_1). The control circuit 126_1 of the AP 104_1 may check the incremental update ID carried by the TSF information frame F_TSF1 to determine whether to adjust the TSF timer 132_2. When the TSF synchronization revision indicated by the incremental update ID reveals that TSF synchronization of the AP 104_1 is needed, the control circuit 126_1 of the AP 104_1 refers to the TSF timing and the timing offset both indicted by the TSF information frame F_TSF1 to adjust the TSF timer 132_2 for synchronizing with the AP 102. For example, the current value counted by the TSF timer 132_2 is updated to be equal to the TSF timing plus the timing offset. In this way, both of the TSF timers 122 and 132_2 have the same value after TSF synchronization of the AP 104_1 is performed based on the TSF synchronization date carried by the TSF information frame F_TSF1.

Similarly, the network interface circuit 127_N (particularly, RX circuit 130_N of network interface circuit 127_N) of the AP 104_N (which acts as a non-master AP) also receives the same TSF information frame F_TSF1 sent from the network interface circuit 117 (particularly, TX circuit 118 of network interface circuit 117) of the AP 102 (which acts as a master AP), and the control circuit 126_N of the AP 104_N obtains the TSF information frame F_TSF1 from the network interface circuit 127_N (particularly, RX circuit 130_N of network interface circuit 127_N). The control circuit 126_N of the AP 104_N may check the incremental update ID carried by the TSF information frame F_TSF1 to determine whether to adjust the TSF timer 132_N. When the TSF synchronization revision indicated by the incremental update ID reveals that TSF synchronization of the AP 104_N is needed, the control circuit 126_N of the AP 104_N refers to the TSF timing and the timing offset both indicated in the TSF information frame F_TSF1 to adjust the TSF timer 132_N for synchronizing with the AP 102. For example, the current value counted by the TSF timer 132_N is updated to be equal to the TSF timing plus the timing offset. In this way, both of the TSF timers 122 and 132_N have the same value after TSF synchronization of the AP 104_N is performed based on the TSF synchronization date carried by the TSF information frame F_TSF1.

After TSF synchronization of APs 104_1-104_N is completed, all of the TSF timers 122 and 132_1-132_N at different APs 102, 104_1-104_N in the same MAP system 100 are synchronized. The target beacon transmission time (TBTT) of each AP's beacon frame may be the same when beacon intervals are the same. In some embodiments of the present invention, another “beacon transmission time offset” parameter broadcasted in a frame (e.g., the beacon frame itself) by each AP can be used to indicate the beacon transmission timing offset from TBTT so that beacon frames broadcasted by APs 102, 104_1-104_N will not collide at the same time.

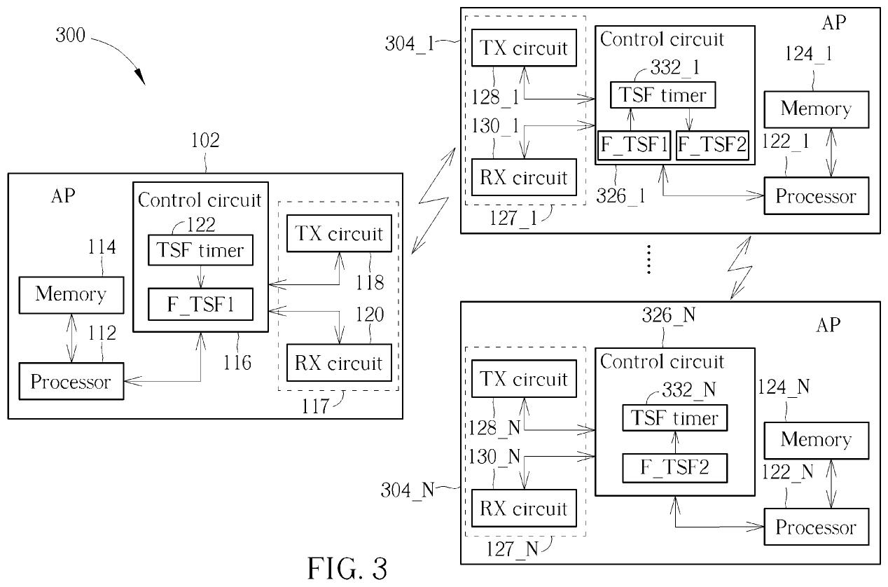

FIG. 3 is a diagram illustrating another MAP system that supports the proposed TSF synchronization scheme according to an embodiment of the present invention. The MAP system 300 may be a Wi-Fi system compliant with IEEE 802.11bn (Wi-Fi 8) standard or a next-generation Wi-Fi standard. The MAP system 300 includes a plurality of APs 102, 304_1-304_N (N≥1). For example, the AP 102 may act as a master AP that initiates TSF synchronization of the MAP system 300, and each of the APs 304_1-304_N may act as a non-master AP that is required to synchronize with the master AP. It should be noted that the MAP system 300 that supports the proposed TSF synchronization scheme may be formed by multiple AP MLDs, multiple non-MLD APs, or a combination thereof.

The APs 102, 304_1-304_N may have the same or similar circuit structure. The major difference between the MAP systems 100 and 300 is that some or all of the APs 304_1-304_N further support a relay function that is used for relaying a TSF information frame to one or more non-master APs that cannot listen to a master AP directly. It should be noted that only the components pertinent to the present invention are illustrated in FIG. 3. In practice, each of APs 102, 304_1-304_N may include additional components to achieve designated functions.

The APs 102, 304_1-304_N in the same MAP system 300 supports the proposed TSF synchronization scheme. The control circuit 116 of the AP 102 (which acts as a master AP) maintains a TSF timer 122 (e.g., a 64-bit counter). The control circuit 326_1 of the AP 304_1 (which acts as a non-master AP) maintains a TSF timer 332_1 (e.g., a 64-bit counter). The control circuit 326_N of the AP 304_N (which acts as a non-master AP) maintains a TSF timer 332_N (e.g., a 64-bit counter). Local clocks of the APs 102, 304_1-304_N may suffer frequency drifting as time goes by. As a result, values counted by TSF timers 122, 332_1, 332_N maintained at different APs 102, 304_1-304_N in the same MAP system 300 may be out of synchronization. To address this issue, a TSF synchronization scheme is proposed by the present invention to make TSF timers at non-master APs synchronized with the TSF timer at the master AP.

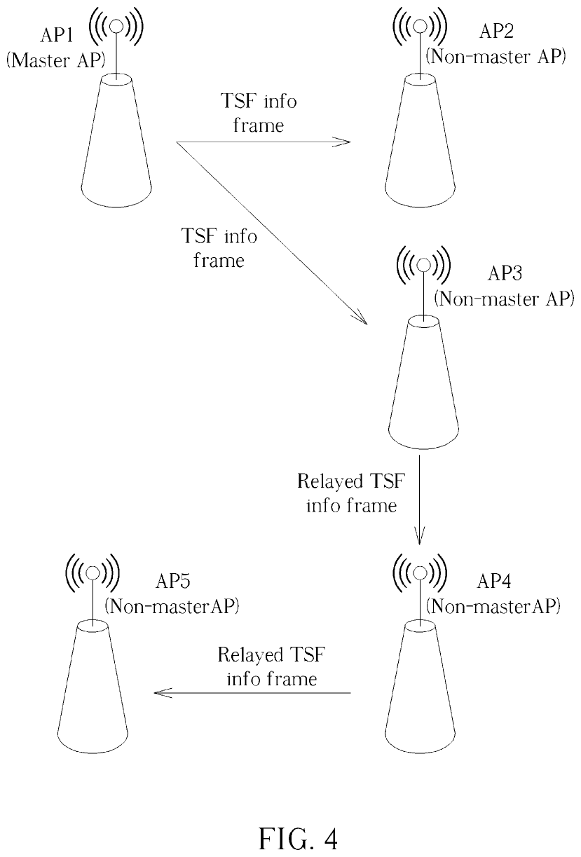

In this embodiment, it is assumed that one AP can listen to another AP through at least one band it operates or through a backhaul, and one or more non-master AP may not listen to the master AP directly. FIG. 4 is a diagram illustrating a second TSF synchronization scenario in an MAP system according to an embodiment of the present invention. The master AP AP1 may be implemented by the AP 102, and the non-master APs AP2, AP3, AP4, AP5 may be implemented by four of the APs 304_1-304_N, where each of the non-master APs AP2 and AP3 can listen to the master AP AP1 directly, each of the non-master APs AP4 and AP5 cannot listen to the master AP AP1 directly, the non-master AP AP4 is a neighbor AP of the non-master AP AP3, and the non-master AP AP5 is a neighbor AP of the non-master AP AP4.

Since the AP 102 acts as the master AP, the AP 102 is in charge of periodically initiating TSF synchronization of the MAP system 300, for ensuring accurate timing synchronization among APs 102, 304_1-304_N in the same MAP system 300. The control circuit 116 of the AP 102 is arranged to generate a TSF information frame F_TSF1, and instruct the network interface circuit 117 (particularly, TX circuit 118 of network interface circuit 117) to send the TSF information frame F_TSF1 to non-master APs that can listen to the master AP directly. For example, the AP 304_1 can listen to the AP 102 directly, and the AP 304_N cannot listen to the AP 102 directly. The TSF information frame F_TSF1 may be a broadcast frame that can be broadcasted to multiple non-master APs in the MAP system 300. For another embodiment, the TSF information frame F_TSF1 may be a unicast frame that can be unicasted to a single non-master AP in the MAP system 300, and the control circuit 116 of the AP 102 needs to generate and send multiple TSF information frames F_TSF1 to multiple non-master APs in the MAP system 300, respectively.

The TSF information frame F_TSF1 is used to carry TSF synchronization data. For example, the TSF synchronization data may include TSF timing of the AP 102 (e.g., a value counted by the TSF timer 122 at the instant the transmission of TSF information frame F_TSF1 occurs/starts), a timing offset corresponding to a delay resulting from processing and transmission of the TSF information frame F_TSF1, an incremental update ID indicative of a TSF synchronization revision, or a combination thereof.

The network interface circuit 127_1 (particularly, RX circuit 130_1 of network interface circuit 127_1) of the AP 304_1 (which acts as a non-master AP) receives the TSF information frame F_TSF1 sent from the network interface circuit 117 (particularly, TX circuit 118 of network interface circuit 117) of the AP 102 (which acts as a master AP), and the control circuit 326_1 of the AP 304_1 obtains the TSF information frame F_TSF1 from the network interface circuit 127_1 (particularly, RX circuit 130_1 of network interface circuit 127_1). The control circuit 326_1 of the AP 304_1 may check the incremental update ID carried by the TSF information frame F_TSF1 to determine whether to adjust the TSF timer 332_2. When the TSF synchronization revision indicated by the incremental update ID reveals that TSF synchronization of the AP 304_1 is needed, the control circuit 326_1 of the AP 304_1 refers to the TSF timing and the timing offset both indicated by the TSF information frame F_TSF1 to adjust the TSF timer 332_1 for synchronizing with the AP 102. For example, the current value counted by the TSF timer 332_1 is updated to be equal to the TSF timing plus the timing offset. In this way, both of the TSF timers 122 and 332_1 have the same value after TSF synchronization of the AP 304_1 is performed based on the TSF synchronization date carried by the TSF information frame F_TSF1.

In this embodiment, the AP 304_N is unable to listen to the AP 102 directly, and registers as a neighbor AP of the AP 304_1. The AP 304_1 enables a relay function to provide a relayed TSF information frame to the AP 304_N for TSF synchronization. For example, the control circuit 326_1 of the AP 304_1 is arranged to generate a TSF information frame F_TSF2, and instruct the network interface circuit 127_1 (particularly, TX circuit 128_1 of network interface circuit 127_1) to send the TSF information frame F_TSF2 to its neighbor AP(s), including the AP 304_N.

Like the TSF information frame F_TSF1, the TSF information frame F_TSF2 may be a broadcast frame or a unicast frame, and is used to carry TSF synchronization data. For example, the TSF synchronization data may include TSF timing of the AP 304_1 (e.g., a value counted by the TSF timer 332_1 at the instant the transmission of TSF information frame F_TSF2 occurs/starts), a timing offset corresponding to a relay delay resulting from processing and transmission of the TSF information frame F_TSF2, an incremental update ID indicative of a TSF synchronization revision, or a combination thereof. Since TSF timer 332_1 of AP 304_1 is synchronized with TSF timer 122 of AP 102, the TSF timing of the AP 304_1 indicated by the TSF information frame F_TSF2 is the same as the TSF timing of the AP 102, the TSF information frame F_TSF2 may be regarded as a relayed TSF information frame that carries the TSF timing of the AP 102. In addition, the incremental update ID indicated by the relayed TSF information frame (i.e., TSF information frame F_TSF2) needs to be the same as the incremental update ID indicated by the TSF information frame F_TSF1.

The network interface circuit 127_N (particularly, RX circuit 130_N of network interface circuit 127_N) of the AP 304_N receives the relayed TSF information frame (i.e., TSF information frame F_TSF2) sent from the network interface circuit 127_1 (particularly, TX circuit 128_1 of network interface circuit 127_1) of the AP 304_1, and the control circuit 326_N of the AP 304_N obtains the relayed TSF information frame (i.e., TSF information frame F_TSF2) from the network interface circuit 127_N (particularly, RX circuit 130_N of network interface circuit 127_N). The control circuit 326_N of the AP 304_N may check the incremental update ID carried by the relayed TSF information frame (i.e., TSF information frame F_TSF2) to determine whether to adjust the TSF timer 332_N. When the TSF synchronization revision indicated by the incremental update ID reveals that TSF synchronization of the AP 304_N is needed, the control circuit 326_N of the AP 304_N refers to the TSF timing and the timing offset both carried by the relayed TSF information frame (i.e., TSF information frame F_TSF2) to adjust the TSF timer 332_N for synchronizing with the AP 102. For example, the current value counted by the TSF timer 332_N is updated to be equal to the TSF timing plus the timing offset. In this way, both of the TSF timers 122 and 332_N have the same value after TSF synchronization of the AP 304_N is performed based on the TSF synchronization date carried by the relayed TSF information frame (i.e., TSF information frame F_TSF2).

As shown in FIG. 4, the non-master AP AP4 is unable to listen to the master AP AP1 directly, and registers as a neighbor AP of the non-master AP AP3. Suppose that the master AP AP1 is implemented by AP 102, the non-master AP AP3 is implemented by AP 304_1, and the non-master AP AP4 is implemented by AP 304_N. Hence, with the help of the relayed TSF information frame (i.e., TSF information frame F_TSF2) unicasted/broadcasted from the non-master AP AP3, the TSF timing of the non-master AP AP4 can be synchronized with the TSF timing of the non-master AP AP4.

As shown in FIG. 4, the non-master AP AP5 is unable to listen to the master AP AP1 directly, and registers as a neighbor AP of the non-master AP AP4. Suppose that the non-master AP AP5 is implemented by AP 304_i (i≠1 & i≠N). Like the AP 304_1, the AP 304_N can enable the same relay function for generating a relayed TSF information frame and send the relayed TSF information frame to AP 304_i after TSF timer 332_N is synchronized with TSF timers 122 and 332_1. Similarly, the updated ID indicated by the relayed TSF information frame generated by the AP 304_i needs to the same as the updated ID indicated by the TSF information frame F_TSF1. As the relay function performed by the AP 304_i is the same as that performed by the AP 304_N, further description is omitted here for brevity.

In some embodiments of the present invention, the update ID also can avoid duplicated receive of the relayed TSF information frame (which corresponds to the TSF information frame sent from the master AP) when one non-master AP (which cannot listen to the master AP directly) registers as neighbor APs of multiple non-master APs.

As mentioned above, the master AP is in charge of periodically initiating TSF synchronization of the MAP system. However, the master AP may not provide the TSF information frame (which can be a beacon frame or any frame that can carry the information needed by TSF synchronization) because of many reasons. In some cases, the master AP may be unavailable at a known timing. For example, the master AP needs to shut down for maintenance or other technical reasons, and the MAP system can expect the timing the master AP becomes offline. In other cases, the master AP may be unavailable at an unknown timing. For example, the master AP may suffer sudden power loss, or the connection of the backhaul to the master AP may break. To keep TSF synchronization working in the MAP system when the master AP becomes unavailable, the present invention further proposes several error handling designs, including a first error handling design and a second error handling design. The first error handling design can be employed to select a new master AP under a condition that a current master AP is unavailable at an unknown timing (e.g., the current master AP goes offline unexpectedly for a certain period or for loss of several TSF information frames), and can be employed to select a new master AP under a condition that a current master AP is unavailable at a known timing (e.g., the current master AP knows it is going to be offline at a predetermined timing). The second error handling design can be employed to select a new master AP under a condition that a current master AP is unavailable at a known timing (e.g., the current master AP knows it is going to be offline at a predetermined timing).

In accordance with the first error handling design, a ranking method is employed to assign a unique rank to each AP during the MAP system setup. For example, the master AP is assigned with rank 1, and the non-master APs are assigned with rank 2, rank 3, and so forth. In this way, each online AP in the MAP system is assigned with a unique rank at the time the master AP goes offline. When a current master AP that initiates TSF synchronization of the MAP system becomes offline, an online AP with a highest rank (e.g., rank 2) among all online APs of the MAP system is selected to act as a new master AP. The rank setting of the selected online AP is updated to rank 1 after the selected online AP takes over the master AP role. In addition, rank settings of other online APs in the same MAP system may be adjusted after the selected online AP takes over the master AP role. For example, other APs' ranks may move up by 1 accordingly. Regarding a new AP that joins the MAP system after the initial setup, it is assigned with a unique rank different from rank 1 possessed by the master AP. Other APs' ranks may change, depending upon the rank assigned to the new AP. For example, if the new AP is assigned with rank 2, an AP originally ranked 2 may change to a new rank other than rank 2. The same rule may be applied when the original master AP joins the MAP system again after unavailability.

In accordance with the second error handling design, before a current master AP that initiates TSF synchronization of the MAP system is expected to be offline at a predetermined timing, the current master AP sends a broadcast frame to other APs (i.e., non-master APs) in the MAP system, where the broadcast frame is set to indicate which non-master AP is appointed as a new master AP that takes over the master AP role for periodically initiating TSF synchronization of the MAP system after the current master AP becomes offline. In some embodiments of the present invention, the broadcast frame is further set to indicate the predetermined timing at which the current master AP becomes offline. In some embodiments of the present invention, the broadcast frame is further set to indicate functions to be provided by the new mater AP. In addition to the TSF synchronization function, the new mater AP may provide additional functions required by the MAP system. Furthermore, some existing functions supported by the current mater AP may not be provided by the new master AP. That is, some functions not mandatorily required by the MAP system may cease when the new master AP goes online.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A timing synchronization function (TSF) synchronization method comprising:
generating a first TSF information frame, wherein the first TSF information frame comprises first TSF synchronization data, and the first TSF synchronization data comprises TSF information of a first access point (AP) of a multi-AP (MAP) system; and
sending the first TSF synchronization frame to a second AP of the MAP system.

2. The TSF synchronization method of claim 1, wherein the first TSF information frame is generated and sent by the first AP acting as a master AP that initiates TSF synchronization of the MAP system, and the second AP acts as a non-master AP.

3. The TSF synchronization method of claim 2, wherein the first TSF information frame is generated and sent by the master AP, periodically.

4. The TSF synchronization method of claim 2, wherein the first TSF synchronization data further comprises a timing offset corresponding to a delay resulting from processing and transmission of the first TSF information frame.

5. The TSF synchronization method of claim 2, wherein the first TSF synchronization data further comprises an update identifier (ID) indicative of a TSF synchronization revision.

6. The TSF synchronization method of claim 1, wherein the first TSF information frame is generated and sent by the first AP, and each of the first AP and the second AP acts as a non-master AP distinct from a master AP that initiates TSF synchronization of the MAP system.

7. The TSF synchronization method of claim 6, further comprising:
receiving a second TSF information frame from a third AP of the MAP system, wherein the second TSF information frame comprises second TSF synchronization data, and the second TSF synchronization data comprises TSF information of the third AP;
wherein TSF synchronization of the first AP is performed based at least partly on the TSF information of the third AP.

8. The TSF synchronization method of claim 7, wherein the third AP acts as the master AP.

9. The TSF synchronization method of claim 7, wherein the third AP acts as a non-master AP.

10. The TSF synchronization method of claim 6, wherein the first TSF synchronization data further comprises a timing offset corresponding to a delay resulting from processing and transmission of the first TSF information frame.

11. The TSF synchronization method of claim 6, wherein the first TSF synchronization data further comprises an update identifier (ID) indicative of a TSF synchronization revision, and the update ID carried by the first TSF information frame is equal to an update ID carried by the second TSF information frame.

12. The TSF synchronization method of claim 1, wherein the first TSF information frame is a broadcast frame.

13. The TSF synchronization method of claim 1, wherein the first TSF information frame is a unicast frame.

14. The TSF synchronization method of claim 1, wherein each online AP in the MAP system is assigned with a unique rank; and the TSF synchronization method further comprises:
in response to a current master AP that initiates TSF synchronization of the MAP system becoming offline, selecting an online AP with a highest rank among all online APs of the MAP system to act as a new master AP.

15. The TSF synchronization method of claim 1, wherein the TSF synchronization method further comprises:
before a current master AP that initiates TSF synchronization of the MAP system is expected to be offline at a predetermined timing, sending a broadcast frame to non-master APs in the MAP system, wherein the broadcast frame is set to indicate which non-master AP is appointed as a new master AP that takes over the TSF synchronization of the MAP system after the current master AP becomes offline.

16. The TSF synchronization method of claim 15, wherein the broadcast frame is further set to indicate the predetermined timing at which the current master AP becomes offline, or functions to be provided by the new master AP.

17. A timing synchronization function (TSF) synchronization method comprising:
receiving a TSF information frame, wherein the TSF information frame comprises TSF synchronization data, and the TSF synchronization data comprises TSF information of a first access point (AP) of a multi-AP (MAP) system; and
performing TSF synchronization of a second AP of the MAP system according to the first TSF synchronization data.

18. The TSF synchronization method of claim 17, wherein the first AP acts as a master AP that initiates TSF synchronization of the MAP system, and the second AP acts as a non-master AP.

19. The TSF synchronization method of claim 17, wherein each of the first AP and the second AP acts as a non-master AP distinct from a master AP that initiates TSF synchronization of the MAP system.

20. An access point (AP) of a multi-AP (MAP) system, comprising:
a network interface circuit; and
a control circuit, arranged to generate a TSF information frame, and instruct the network interface circuit to send the TSF information frame to another AP of the MAP system;
wherein the TSF information frame comprises TSF synchronization data, and the TSF synchronization data comprises TSF information of the AP.
